(19) United States
(12) Patent Application Publication
(10) Pub. No.: US 2026/0181575 A1
(43) Pub. Date: Jun. 25, 2026

(54) GRAPHENE-BASED PHASED ARRAY ANTENNA FOR DEVICE TRACKING

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/799,909

(22) Filed: Aug. 9, 2024

(51) Int. Cl. H04W 64/00

(52) U.S. Cl. CPC H04W 64/00

(57) ABSTRACT

A system for wireless device tracking includes a graphene phased array antenna configured to receive wireless signals from a plurality of wireless devices in an environment, a signal processor configured to detect and determine a location of each of the plurality of wireless devices in the environment; and a network interface configured to transmit the location of each of the plurality of wireless devices to a remote system.

### TECHNICAL FIELD

The present disclosure is generally related to device tracking and more specifically to tracking devices using a graphene phased array antenna.

### BACKGROUND

Currently, managing a high density of devices within a wireless base station environment presents significant challenges in terms of signal congestion and interference. Traditional antennas suffer from higher signal loss and lower conductivity, impacting overall signal quality and communication reliability. In addition, efficiently facilitating the reception and transmission of signals within a dense network environment requires advanced hardware and software integration. Processing received signals to accurately determine the location of target devices is complicated by noise and interference, necessitating sophisticated signal processing techniques. Outlier signals can distort tracking data, leading to inaccuracies in device location and movement predictions. Precise synchronization of signal processing operations is difficult without high-speed and accurate timing mechanisms. Lastly, designing and simulating complex antenna systems, especially those using new materials like graphene, require specialized electromagnetic CAD tools to optimize performance. Environments requiring high accuracy, such as synthetic aperture radar and sound demodulation from radio waves, face challenges in maintaining low noise levels and high signal integrity.

### SUMMARY

Disclosed herein is an graphene phased array antenna for device tracking that overcomes the problems and disadvantages of conventional approaches. According to one aspect, a system for wireless device tracking includes a graphene phased array antenna configured to receive wireless signals from a plurality of wireless devices in an environment, where the graphene phased array antenna includes graphene-based phase shifters arranged in a predetermined configuration. The system also includes a signal processor configured to calculate an angle from which each wireless signal arrives to triangulate a location of each wireless device within the environment based on relative phase shifts caused by different paths the wireless signals take to reach each graphene-based phase shifter of the graphene phased array antenna. The system further includes an integration module configured to optimize performance of the graphene phased array antenna based on one or more conditions in the environment. Additionally, the system includes a network interface configured to transmit the location of each of the plurality of wireless devices to a remote system.

In some configurations, the one or more conditions in the environment include one or more of temperature or humidity and the integration module includes a resistance monitoring module configured to provide real-time monitoring of changes of resistance of the graphene-based phase shifters due to the one or more conditions in the environment. The integration module is configured to adjust one or more parameters of the graphene phased array antenna in response to the changes of resistance. In certain implementations, the one or more parameters include amplifier gain or filter bandwidth.

In various embodiment, the integration module includes an electromagnetic interference (EMI) module configured to provide real-time monitoring of changes of EMI in the environment. The integration module is configured to filter out or compensate for detected EMI.

In additional embodiments, the integration module includes an integrity module configured to continuously monitor the graphene-based phase shifters for one or more signs of a physical change in structure, and wherein the integration module is configured, in response to detecting the one or more signs of the physical change in the structure of the graphene-based phase shifters, to generate an alert. In certain configurations, the one or more signs of the physical change in the structure of the graphene-based phase shifters include strain, deformation, or vibration.

In further embodiments, the integration module includes a signal monitoring module configured to continuously monitor signals received or transmitted by the graphene-based phase shifters. The integration module is configured, in response to detecting signal strengths outside of a predetermine range, to dynamically adjust one or both of transmission power and reception sensitivity of the graphene phased array antenna.

In certain embodiments, the integration module includes an impedance module configured to monitor an impedance of the graphene-based phase shifters and adjust the impedance in response to detection of an impedance mismatch.

In some implementations, the graphene phased array antenna is configured to operate in a passive mode without transmitting a wireless signal to the plurality of wireless devices. In other implementations, the graphene phased array antenna is further configured, prior to receiving the wireless signals, to transmit at least one wireless signal to the plurality of wireless devices, and the graphene phased array antenna is configured to operate as an Active Electronically Scanned Array (AESA), where each graphene-based phase shifter is equipped with individual transmit/receive modules allowing for independent control of each graphene-based phase shifter. In certain embodiments, the individual transmit/receive modules are configured to perform at least one of actively steering beams, scanning multiple directions simultaneously, providing targeting and tracking capabilities, and providing beam shaping and adaptation to changing signal environments.

In certain implementations, the signal processor includes a Kalman module configured to predict a position in the environment of each wireless device of the plurality of wireless devices by filtering and smoothing the wireless signals. The Kalman module is further configured to: initialize a state vector representing the position and a velocity of a first wireless device, the state vector being based on initial measurements obtained from the graphene phased array antenna; and use a Kalman filter to predict a future state of the first wireless device using a mathematical model. In some examples, the mathematical model considers a previous state and incorporates one or more assumptions about movement of the first wireless device to make a prediction by calculating a predicted state vector and an associated uncertainty using a covariance matrix. The one or more assumptions may include at least one of constant velocity or acceleration. The Kalman module compares the predicted state vector with actual measurements to compute a residual, and the Kalman filter adjusts the state vector and the covariance matrix based on the residual.

In some configurations, the system further includes a track module configured to match the wireless signals to respective tracked devices by preprocessing the wireless signals to extract signal features and, for each incoming signal, comparing the extracted signal features to generate a list of potential matches from an existing set of tracked devices. The extracted signal features may include one or more of signal strength, time of arrival, and angle of arrival.

In certain implementations, the system further includes a Joint Probabilistic Data Association (JPDA) module configured to optimize assignment of the wireless signals to wireless devices. The JPDA module is configured, in some examples, to evaluate all possible assignments and select a first assignment that maximizes an overall likelihood of being a match. The JPDA module calculates a likelihood score based on consistency of the extracted signal features with expected values for each tracked wireless device.

According to another aspect, a method for wireless device tracking includes receiving, via a graphene phased array antenna, wireless signals from a plurality of wireless devices in an environment, where the graphene phased array antenna includes graphene-based phase shifters arranged in a predetermined configuration. The method also includes calculating, via a signal processor, an angle from which each wireless signal arrives to triangulate a location of each wireless device within the environment based on relative phase shifts caused by different paths the wireless signals take to reach each graphene-based phase shifter of the graphene phased array antenna. The method further includes optimizing performance of the graphene phased array antenna based on one or more conditions in the environment. Additionally, the method includes transmitting the location of each of the plurality of wireless devices to a remote system.

### BRIEF DESCRIPTION OF THE DRAWINGS

FIG. 1 is a schematic diagram of a system for device tracking using a graphene phased array antenna.

FIG. 2 is a flowchart of a method performed by an advanced signal processing (ASP) module.

FIG. 3 is a flowchart of a method performed by an Integration Module.

### DETAILED DESCRIPTION

Embodiments of the present disclosure will be described more fully hereinafter with reference to the accompanying drawings in which like numerals represent like elements throughout the several figures. Aspects of the disclosed systems and methods may be embodied in many different forms and should not be construed as limited to the embodiments set forth herein. The examples set forth herein are non-limiting and are merely some among many possible examples.

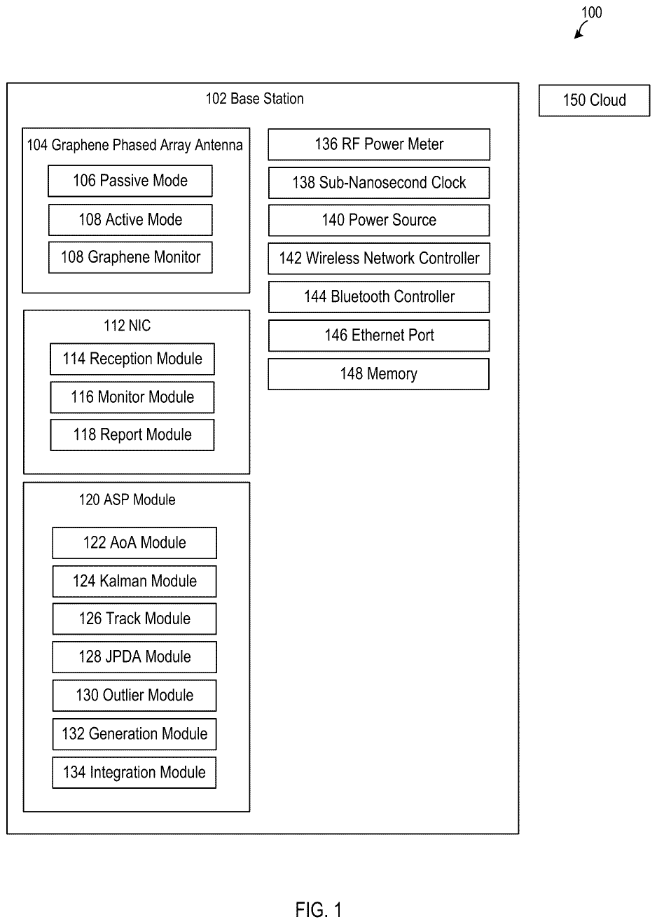

FIG. 1 is a schematic diagram of a system 100 for device tracking. In some embodiments, the system 100 includes a base station 102, which operates with a graphene phased array antenna 104 to manage a high density of devices within an environment. The base station 102 captures and processes incoming wireless signals using graphene-based phase shifters of the graphene phased array antenna 104, which leverage graphene's unique properties to offer precise phase control, reduced signal loss, and high-speed switching capabilities.

The graphene phased array antenna 104 operates in passive mode 106 and active mode 108, allowing it to discreetly monitor all wireless traffic within its vicinity without establishing any connection or interaction with the devices being monitored. The passive monitoring approach enables the detection of wireless signals from various devices, ensuring that the devices remain unaware of the monitoring activity. The base station 102 captures a variety of wireless frames, focusing on management frames such as probe requests, which provide details like MAC addresses, SSIDs, signal strength, supported rates, and other significant metadata of the wireless devices.

The base station 102 periodically scans different frequency channels to ensure comprehensive coverage of the wireless environment. It may employ various techniques, such as channel hopping, to enhance its detection capability and minimize the chances of missing any signals. Once a wireless frame is captured, the base station 102 performs data extraction to isolate relevant information, such as MAC addresses, network names (SSIDs), and signal strengths. This extracted data forms the basis for further analysis and processing. Initial preprocessing of the captured data involves filtering out any irrelevant or redundant information, refining the data set, and ensuring that only valuable and pertinent information is retained.

The graphene phased array antenna's 104 integration into the base station 102 provides for sophisticated angle of arrival operations to determine the location of target devices. The system applies advanced radar mathematics, including Kalman filters and Joint Probabilistic Data Association (JPDA) operations, to process received signals, remove outliers, and generate accurate tracking data. This approach enables efficient tracking and communication in environments with a large number of devices. The base station 102 may be designed and simulated using electromagnetic CAD tools. It may incorporate a high-speed RF power meter 136 and a sub-nanosecond clock 138 to ensure precise signal processing and synchronization, making it highly suitable for applications requiring high accuracy and low noise, such as synthetic aperture radar and sound demodulation from radio waves.

Further, embodiments may include a graphene phased array antenna 104, which includes a phased array of elements that may function in both passive and active modes. In the passive mode, the antenna 104 does not transmit any signals but listens to all wireless traffic within its vicinity, capturing signals without interacting with the devices being monitored. This passive approach allows for discreet monitoring and reduces the likelihood of detection by the tracked devices. In the active mode, the antenna 104 can transmit signals and then receive the reflected signals back, enabling more dynamic interaction with the environment.

In some embodiments, graphene may be utilized in the phase shifters associated with the antenna 104 due to its exceptional electrical properties, such as ultra-low resistance and high conductivity, which enable precise phase control and reduced signal loss to provide accurate beam steering and signal processing. In some embodiments, the use of graphene-based phase shifters enhances the sensitivity and precision of the antenna 104 system, allowing for improved device tracking and more efficient signal transmission.

In some embodiments, the antenna 104 may operate as either an Active Electronically Scanned Array (AESA) or a passive array, depending on its configuration. In some embodiments, in the AESA configuration, each antenna 104 element may be equipped with individual transmit/receive modules, allowing for independent control of each element, enabling the antenna 104 to actively steer beams, scan multiple directions simultaneously, and provide precise targeting and tracking capabilities. In some embodiments, the AESA configuration may allow for rapid beam shaping and adaptation to changing signal environments, making it highly effective for applications like missile guidance and air traffic control.

In some embodiments, in the passive configuration, the antenna 104 elements may share common transmit/receive modules, relying on a central controller for beam steering and signal processing, which may be utilized for various applications, including satellite communications and surface ship radar. In some embodiments, the passive array may provide good range and resolution, leveraging the combined signals from all elements to enhance overall performance. In some embodiments, the antenna 104 array may be capable of operating across diverse frequency ranges to support various applications, from consumer wireless communication to advanced military radar systems.

In some example embodiments, the antenna 104 array may be designed to operate at 2.4 GHz and/or 5 GHz for Wi-Fi or Bluetooth applications, with each antenna element being 2.1 inches in size, forming a 16-channel array that measures approximately 20 inches by 20 inches. In some embodiments, the antenna 104 array may be designed to operate at X-band, such as 8-12 GHz, S-band, such as 2-4 GHz, C-band, such as 4-8 GHz, or L-band, such as 1-2 GHz, which are used in various applications such as missile guidance, air traffic control, surface ship radar, satellite communications, and long-range radar systems, offering a range of capabilities including good resolution, range, and weather penetration. In some embodiments, the antenna 104 array may be designed to operate at various cellular frequencies, such as 700-800 MHz for long-distance LTE communication with good building penetration, 1.7-2.1 GHz for LTE and 3G/4G services balancing coverage and data speeds, or 2.3-2.7 GHz for higher data rates in LTE-A and 5G over shorter distances, which provides varying benefits in terms of range and data throughput. In some embodiments, the configuration may allow the antenna 104 to cover a wide area and detect signals from multiple devices simultaneously. The array's design may support both angle of arrival (AoA) measurements and Doppler shift calculations, which may be used to determine the direction and movement of the tracked devices.

In some embodiments, the antenna 104 may include a null space reduction module, which helps identify and minimize the effects of nulls or dead zones in the signal reception pattern. The null space reduction module works by analyzing the signals received from different antennas in the array and adjusting the reception parameters to improve signal clarity and reduce interference. In some embodiments, the graphene phased array antenna 104 may be integrated with an integration module 134. The integration module 134 may continuously monitor the resistance of the graphene phase shifters, which can vary due to environmental factors such as temperature and humidity. By measuring and adjusting for these variations in real time, the system ensures optimal signal reception and processing accuracy. In some embodiments, the graphene phased array antenna 104 may support advanced signal processing capabilities. The graphene phased array antenna may work in conjunction with tools such as the Kalman filter for prediction and smoothing of device positions, the Joint Probabilistic Data Association, or JPDA, for accurate data association in environments with multiple devices, and outlier module 130 to eliminate false signals and improve overall tracking accuracy.

In some embodiments, the antenna 104 elements of the array may be manufactured using advanced fabrication techniques, including extreme ultraviolet or EUV lithography, to achieve either flat or protruding dipole designs, depending on the specific application requirements. In some embodiments, the flat design may include most of the circuitry, including control and signal processing components, being printed directly onto the substrate using EUV lithography, allowing for highly compact and efficient circuitry that optimizes the elements for performance while maintaining a low profile. In some embodiments, the flat design may be beneficial for applications requiring minimal physical footprint and aerodynamic efficiency, such as in certain types of mobile or aerial systems. In some embodiments, the antenna 104 elements may include protruding dipole antennas for applications that demand enhanced signal strength or specific directional properties. The dipoles, which may be as large as 6 inches each, may be integrated into slots within the elements after the initial circuitry is printed. In some embodiments, the protruding dipole design may maximize the effective aperture of each antenna 104 element, enhancing signal reception and transmission capabilities. In some embodiments, the protruding dipole design may be useful in applications such as long-range radar, satellite communications, and other scenarios where signal integrity over large distances is desirable.

In some embodiments, the use of deep ultraviolet, or DUV, lithography may complement EUV lithography in both antenna designs, which allows for even finer feature creation and greater detail in the printed circuits. In some embodiments, the combination of EUV and DUV lithography may ensure that both flat and dipole-protruding antenna 104 elements may be manufactured with high precision, excellent electrical properties, and minimal signal loss. In some embodiments, other advanced printing techniques, such as inkjet and screen printing, may also be employed to apply conductive inks or specialized coatings, further enhancing the electrical and thermal performance of the antenna 104 elements. In some embodiments, the coatings may improve signal conductivity, reduce interference, and protect the elements from environmental factors to ensure longevity and reliability.

Further, embodiments may include a passive mode 106 of the graphene phased array antenna 104, which allows the graphene phased array antenna 104 to operate without transmitting any signals. The graphene phased array antenna 104 passively listens to all wireless traffic within its vicinity, capturing signals discreetly. The passive mode 106 allows for applications that require undetectable monitoring, as the devices being tracked remain unaware of the surveillance. In passive mode 106, the antenna 104 may capture a variety of wireless frames, focusing on management frames like probe requests. These frames contain various types of information, such as MAC addresses, SSIDs, signal strengths, supported rates, and other metadata from nearby wireless devices. By capturing this data, the system can identify and track devices without initiating any communication with them. In some embodiments, the antenna 104 may periodically scan different frequency channels. This scanning process allows the system to detect devices operating across various channels, minimizing the chances of missing any signals. In some embodiments, the antenna 104 may employ channel hopping, frequently switching between channels at specified intervals, which enhances the range of frequencies monitored and the detection capability by reducing the likelihood of undetected signals.

Further, embodiments may include an active mode 108, which allows for the graphene phased array antenna 104 to operate by actively transmitting and receiving signals, enhancing its ability to detect and track devices with greater precision and range, which involves a more dynamic interaction with the wireless environment, enabling the system to perform more sophisticated functions. In some embodiments, in active mode 108, the antenna 104 may emit signals that propagate through the environment, which then reflect off objects and devices. These reflected signals are captured by the antenna 104 arrays, allowing for detailed analysis and tracking. In some embodiments, active mode 108 may perform a Doppler shift analysis. By emitting a known signal and analyzing the frequency shift of the reflected signal, the system can determine the relative velocity and movement of tracked devices for applications that require real-time monitoring of device trajectories. In some embodiments, the active mode 108 may enable the use of advanced signal processing techniques, such as beamforming. Beamforming allows the antenna 104 to focus its transmission and reception capabilities in specific directions, enhancing signal strength and reception quality in targeted areas. Directional control may be achieved by adjusting the phase and amplitude of the signals transmitted by each element in the antenna 104 array, creating constructive interference in the desired direction.

In some embodiments, the system may continuously monitor the quality of the transmitted and received signals, making real-time adjustments to optimize performance, including adapting the transmission power, frequency, and beamforming parameters to account for environmental changes and interference. The real-time resistance monitoring of the elements ensures that the antenna 104 maintains optimal performance, even in varying environmental conditions. In some embodiments, the active mode 108 may facilitate the integration of multiple signal processing modules, such as the Kalman module 124 and JPDA module 128, to enhance the accuracy and reliability of the tracking system. The Kalman module 124 may predict the future positions of tracked devices based on their current and past states. In contrast, the JPDA module 128 may ensure that the correct signals are matched to the appropriate devices, even in crowded environments with many signals.

Further, embodiments may include a graphene monitor 110, which may continuously track the electrical properties of graphene-based switches, specifically their resistance, to ensure the stability and performance of the phased array antenna system. In some embodiments, the graphene monitor 110 may assist in detecting environmental influences, component aging, and other factors that may affect the system's operation. For example, the graphene monitor 110 may measure the input resistance of the transmission line before the signal reaches the graphene switches and measure the output resistance after the signal has passed through the graphene switch. In some embodiments, sensors that measure temperature, humidity, and other relevant environmental parameters may be installed in the system to help correlate changes in graphene resistance with environmental conditions.

In some embodiments, the four-point probe method may be utilized to accurately measure the resistance across the graphene switches, which may minimize contact resistance errors by using separate probes for current injection and voltage measurement. In some embodiments, a high-resolution voltmeter and ammeter may be used to ensure precise current and voltage readings for accurate resistance calculation. In some embodiments, the graphene monitor 110 may connect to all sensors and measurement instruments for real-time monitoring and data logging. In some embodiments, the graphene monitor 110 may collect resistance data at regular intervals, such as every millisecond, to ensure continuous monitoring.

The graphene monitor 110 may log environmental data alongside resistance measurements to enable correlation analysis. The graphene monitor 110 may apply signal processing techniques to filter out noise from the resistance data, ensuring accurate and reliable readings. The graphene monitor 110 may normalize the data to account for baseline variations and facilitate comparison across different measurement sessions. The graphene monitor 110 may establish resistance thresholds that indicate normal operation versus potential issues, which may be based on historical data and manufacturer specifications. The graphene monitor 110 may analyze trends in resistance changes over time to detect gradual shifts that may indicate environmental effects, device aging, or other anomalies. The graphene monitor 110 may use statistical methods to correlate changes in graphene resistance with environmental factors such as temperature and humidity and may identify patterns that suggest specific environmental influences on graphene properties. In some embodiments, the graphene monitor 110 may perform automated adjustments by utilizing a feedback loop to adjust control parameters, such as bias voltage applied to the graphene switches, based on real-time resistance measurements and environmental data. In some embodiments, the graphene monitor 110 may adjust the phase shifter settings dynamically to compensate for changes in resistance, ensuring consistent phase shifts and beam steering accuracy. In some embodiments, the graphene monitor 110 may change the signal path or activate backup systems based on the monitoring data.

Further, embodiments may include a network interface card, or NIC 112, which may be a hardware component that enables the base station 102 to connect to a network. The NIC 112 may be designed to handle all the functions for establishing and maintaining network communication. In some embodiments, the NIC 112 may include several components, such as the network interface controller, transceivers, and connectors, housed on a single board. The NIC 112 may operate by interfacing with the base station's 102 operating system and network software to manage data transmission and reception over a network. In some embodiments, the NIC 112 may provide a physical interface for the network cable, such as Ethernet, Wi-Fi, or other types of network connections. In some embodiments, the NIC 112 may contain transceivers that convert electrical signals to and from network cables into data the base station 102 can process. In some embodiments, the NIC 112 may include connectors and other circuitry to manage the electrical signals and ensure efficient and accurate data transmission. The NIC 112 may prepare data for transmission over the network and to process incoming data. The NIC 112 may encapsulate data packets according to the network protocols being used, manage error detection and correction, and control the flow of data to prevent congestion. The NIC 112 may handle the conversion of data from parallel to serial form for transmission over the network medium and from serial to parallel form upon receipt. In some embodiments, the NIC 112 may include firmware or software that interfaces with the base station's 102 operating system. The software component may be responsible for handling the low-level operations of network communication, such as packet generation, data buffering, and signal encoding/decoding. The NIC 112 firmware may ensure that the hardware functions are abstracted in a way that the operating system can manage network communication seamlessly, allowing for network drivers to facilitate communication between the base station 102 and the network.

In some embodiments, the NIC 112 may include a network interface controller, which may be a chip or a set of integrated circuits that handles the processing of network data and communication tasks. The network interface controller may be responsible for the actual management of data transfer between the computer's internal bus system and the network media. In some embodiments, the network interface controller may manage the sending and receiving of data packets, ensuring that data is transmitted correctly and efficiently across the network. When data is sent from the base station 102, the controller takes parallel data from the base station's 102 bus and converts it into serial data to be sent over the network cable. Conversely, when data is received, the controller converts serial data from the network back into parallel data for the base station 102 to process. In some embodiments, the controller may handle error detection and correction by using various algorithms to check the integrity of the data packets being transmitted and received to ensure that errors are detected and corrected before the data reaches its destination. In some embodiments, the controller may manage the data buffering process by temporarily storing data in buffers to smooth out the differences in data transmission rates between the base station 102 and the network to help manage network congestion and ensure that data flows smoothly without overwhelming either the sending or receiving ends. In some embodiments, the controller may manage network protocols by handling the low-level operations utilized by different network protocols, such as Ethernet or Wi-Fi, including addressing, packet framing, and collision detection and avoidance, allowing the NIC 112 to communicate effectively over various types of networks and ensures compatibility with different networking standards.

Further, embodiments may include a reception module 114, which may initiate the primary functions for the base station 102 to effectively capture and manage wireless signals in its vicinity. The process begins with the base station 102 booting up, which may involve powering the device and initializing its hardware and software components. The reception module 114 enumerates the available network interfaces by identifying and setting up the network interface controllers that will be used for monitoring wireless traffic. In some embodiments, the base station 102 may configure its network interfaces to ensure they are ready for capturing wireless signals. The reception module 114 initiates the monitor module 116, which may continuously monitor wireless traffic within the base station's 102 range. The monitor module 116 may place the NIC 112 into monitor mode, allowing it to passively listen to all wireless traffic without establishing connections with the devices being monitored. The monitor module 116 may periodically scan different frequency channels, capture wireless frames, and preprocess the captured data to extract relevant information such as MAC addresses, SSIDs, and signal strengths. Simultaneously, the reception module 114 may initiate the report module 118, which may be responsible for handling the transmission of the captured and processed data to the servers. The report module 118 may ensure that the collected data is serialized, encrypted, and transmitted securely to the designated servers. The report module 118 may manage the encryption keys, establish secure communication channels, and transmit the data efficiently. The reception module 114 may ensure that the base station 102 continues to perform additional processing as needed, which may include maintaining the base station's 102 operational status, handling any errors or exceptions, and managing dynamic configuration changes. In some embodiments, the reception module 114 may operate in a loop, continuously capturing and processing wireless signals, and reporting the data to the servers until it is terminated.

Further, embodiments may include a monitor module 116, which may be responsible for the continuous surveillance and data collection of wireless traffic in the vicinity of the base station 102. The process begins with the NIC 112 being placed into monitor mode. The NIC 112 may passively listen to all wireless traffic within its range without engaging or connecting to any of the devices being monitored. The passive monitoring allows the base station 102 to detect wireless signals discreetly, ensuring that the devices remain unaware of the monitoring activity. Next, the NIC 112 may change channels periodically, which may involve scanning different frequency channels at specified intervals, typically ranging from 500 to 1500 milliseconds. Channel scanning helps to enable comprehensive coverage of the wireless environment, as devices may operate on various channels. By hopping between channels, the NIC 112 may minimize the chances of missing any wireless signals, thereby enhancing its detection capability. Upon detecting wireless signals, the NIC 112 captures and preprocesses probe request management frames. In some embodiments, the frames may contain information such as MAC addresses, SSIDs, signal strengths, supported rates, and other metadata of the wireless devices. The NIC 112 may isolate the relevant information from the frames, focusing on key details for further analysis and processing. The NIC 112 may perform additional preprocessing on the captured data, which may involve filtering out any irrelevant or redundant information to ensure that only valuable and pertinent data is retained. The preprocessing step refines the data set, making it more manageable and efficient for subsequent processing stages. After preprocessing the data, the NIC 112 may structure the refined data in a format suitable for efficient transmission and subsequent analysis. The structured data provides a comprehensive overview of the detected wireless signals, including the history of wireless networks the devices have previously connected to, MAC addresses, and other significant details. The NIC 112 may store the preprocessed data and then return to scanning channels and monitoring wireless traffic to ensure continuous surveillance of the wireless environment, with the NIC 112 repeatedly capturing, preprocessing, and storing data as new wireless signals are detected.

Further, embodiments may include a report module 118, which may be responsible for securely transmitting the data captured and preprocessed by the monitor module to the designated servers. The report module 118 may ensure that the collected data is transmitted efficiently, securely, and accurately to facilitate further analysis and storage. The report module 118 may begin with the NIC 112 determining which server to send the data to. In some embodiments, the decision may be made using path cost analysis, a technique that evaluates the most efficient and reliable route for data transmission. In some embodiments, the path cost analysis algorithm may consider factors such as connection speed, reliability, and network congestion to identify the optimal server for data transmission. Once the target server is determined, the NIC 112 and the server may exchange public keys to establish an encrypted communication session to ensure the security and integrity of the data during transmission. In some embodiments, public key encryption may be used to create a secure channel between the NIC 112 and the server to prevent unauthorized access to the data. The NIC 112 may receive a session key from the server, which may be encrypted using the NIC's 112 public key to ensure that only the NIC 112 can decrypt and use it. The session key is then used to encrypt the data that will be transmitted, providing an additional layer of security. The NIC 112 serializes the preprocessed data into a structured format suitable for transmission. Serialization may involve converting the data into a format that can be easily transmitted over the network and reconstructed by the receiving server. The serialized data is encrypted using the session key to ensure that it remains secure during transmission. The NIC 112 sends the data to the designated server. The transmission occurs over the established secure communication channel to protect the data from interception and tampering. In some embodiments, the NIC 112 continuously monitors the transmission process to ensure that the data is sent reliably and efficiently. In some embodiments, the report module 118 may include a loop that returns to refresh the secure session key and send additional data as needed. In some embodiments, the loop allows the NIC 112 to maintain a secure communication channel with the server by regularly updating the session key to prevent security breaches. In some embodiments, the process may repeat as long as there is data to transmit, ensuring continuous and secure reporting of the captured wireless signals.

Further, embodiments may include an advanced signal processing (ASP) module 120, which may be responsible for the accurate detection, tracking, and location determination of wireless devices. In some embodiments, the ASP module 120 may integrate multiple specialized sub-modules that collectively process and analyze incoming wireless signals to pinpoint the precise location of devices within the monitored area. In some embodiments, the ASP module 120 may execute an AoA module 122, which may calculate the angle from which each wireless signal arrives to triangulate the position of the signal source. In some embodiments, the ASP module 120 may execute the Kalman module 124, which refines the position estimates of the tracked devices. This module may use the Kalman filtering algorithm, which predicts the future state of a device's position based on its current state and updates these predictions with new incoming signal data to ensure that the position estimates are continually refined, leading to highly accurate tracking results. In some embodiments, the ASP module 120 may execute the track module 126, which ensures that each captured signal is correctly assigned to the appropriate device track. In some embodiments, the track module 118 may use algorithms to match incoming signals with existing tracks to maintain the continuity and accuracy of the tracking data even in environments with multiple overlapping signals. In some embodiments, the track module 126 may oversee the lifecycle of each device track, including the creation of new tracks for newly detected devices, the maintenance of ongoing tracks, and the termination of tracks when a device is no longer detected.

In some embodiments, the ASP module 120 may execute a JPDA module 128, which may handle complex tracking scenarios where multiple devices are present. Using probabilistic methods, the JPDA module 118 may resolve ambiguities and associates signals with the correct tracks, and may clean up any inconsistencies, ensuring that the tracking data remains accurate and reliable.

In some embodiments, the ASP module 120 may execute an outlier module 130, which processes measurements that arrive out of sequence. In some embodiments, wireless signals may not always arrive in the order they were emitted, and the outlier module 130 may ensure that such out-of-sequence data is correctly integrated into the tracking system.

In some embodiments, the ASP module 120 may execute a generation module 132, which may convert raw sensor data into a standardized format that can be used for further processing and analysis within the system. The generation module 132 ensures that the data from various sensors is compatible and can be seamlessly integrated into the tracking workflow.

In some embodiments, the ASP module 120 may execute an integration module 134, which may optimize the performance of the graphene phased array antenna 104 by incorporating various monitoring and adjustment modules, including modules for measuring and monitoring resistance, real-time resistance for receiving circuits, and enhanced reception and transmission. In some embodiments, the integration module 134 features adaptive signal processing, temperature and humidity monitoring, electromagnetic interference detection, structural integrity assessment, signal strength monitoring, frequency response monitoring, and impedance matching. In some embodiments, the modules within the integration module 134 may work together to dynamically optimize the antenna's 104 performance to provide robust and reliable communication by continuously adapting to environmental conditions.

Further, embodiments may include an AoA module 122, which may be responsible for calculating the angle at which incoming wireless signals are received by the system's sensors. By determining the direction from which each signal originates, the AoA module 122 may assist in triangulating the position of the signal-emitting device by measuring the phase difference of the signal at multiple antennas or sensor elements, which allows the AoA module 122 to accurately estimate the angle of arrival. The calculated angles are then used in conjunction with other data, such as signal strength and time of arrival, to pinpoint the precise location of the wireless device.

Further, embodiments may include a Kalman module 124, which may utilize the Kalman filtering algorithm to enhance the accuracy of position estimates for tracked wireless devices. The Kalman module 124 may predict the future state of a device's position based on its current state and historical data, and then update these predictions with new incoming signal data, allowing the Kalman module 124 to continuously refine its estimates, reducing uncertainty and improving the precision of the tracking data. The Kalman module 124 maintains accurate and reliable device tracking, especially in dynamic environments where devices may move unpredictably. By filtering out noise and smoothing the tracking data, the Kalman module 124 ensures that the system can provide precise location information for the monitored devices.

Further, embodiments may include a track module 126, which may be responsible for correctly associating incoming signals with the appropriate device tracks. For example, in environments with multiple devices emitting wireless signals, the track module 126 accurately matches each signal to its corresponding device. The track module 126 may use algorithms to manage this process, ensuring that signals are consistently and correctly linked to the right tracks. The track module 126 maintains the continuity and accuracy of the tracking data, even in complex scenarios where signal overlap or interference may occur. The track module 126 may also oversee the lifecycle of each device track, which includes the creation, maintenance, and termination of tracks for all detected wireless devices. When a new device is detected, the track module 126 initiates a new track for that device, ensuring that it is continuously monitored as long as it remains within the detection area. The track module 126 may maintain ongoing tracks by updating them with new data and adjusting for any changes in the device's position or status. In some embodiments, the track module 126 may terminate tracks when a device is no longer detected, ensuring that the system's resources are efficiently managed.

Further, embodiments may include a JPDA module 128, which may handle complex environments where multiple wireless devices emit overlapping signals. The JPDA algorithm probabilistically associates these signals with the correct device tracks, ensuring accurate tracking despite the challenges of signal overlap and interference. The JPDA module 128 may also include a cleaning function that removes ambiguities and inconsistencies from the tracking data to enhance the reliability and precision of the system.

Further, embodiments may include an outlier module 130, which may integrate measurements that arrive out of sequence into the tracking system. In some embodiments, wireless signals may not always be received in the order they were emitted due to various factors such as network delays or transmission issues. The outlier module 130 may ensure that these out-of-sequence measurements are correctly incorporated into the tracking process, maintaining the continuity and accuracy of the tracking data. By handling out-of-sequence data effectively, the outlier module 130 prevents disruptions in the tracking process and ensures that the system can provide accurate and reliable location information for all monitored devices.

Further, embodiments may include a generation module 132, which may be responsible for converting raw sensor data into a standardized format that can be easily processed and analyzed by the system. In some embodiments, wireless signals captured by the base station 102 may come in various formats and structures, depending on the type of device and signal. The generation module 132 may ensure that all this disparate data is transformed into a consistent and uniform format. In some embodiments, this standardization allows for the seamless integration and subsequent processing of data across the different components of the base station 102. By converting raw sensor data into a usable format, the generation module 132 may facilitate data analysis and ensure the overall functionality and accuracy of the system's tracking and detection processes.

Further, embodiments may include an integration module 134, which may optimize the performance of the graphene phased array antenna 104 by incorporating various monitoring and adjustment modules, including modules for measuring and monitoring resistance, real-time resistance for receiving circuits, and enhanced reception and transmission. In some embodiments, the integration module 134 features adaptive signal processing, temperature and humidity monitoring, electromagnetic interference detection, structural integrity assessment, signal strength monitoring, frequency response monitoring, and impedance matching. In some embodiments, the modules within the integration module 134 may work together to dynamically optimize the antenna's 104 performance to provide robust and reliable communication by continuously adapting to environmental conditions.

Further, embodiments may include an RF power meter 136, which may measure and monitor the power levels of radio frequency signals transmitted and received by the graphene phased array antenna 104. The RF power meter 136 includes a high-precision sensor capable of detecting RF power across a wide range of frequencies, an analog-to-digital converter, or ADC, for accurate signal processing, and a microcontroller unit, or MCU, to manage data collection and analysis. The sensor continuously measures the RF power of signals, converting these measurements into electrical signals that the ADC digitizes. The digitized data is then processed by the MCU, which interprets the power levels and provides real-time feedback to the system. In some embodiments, the RF power meter 136 ensures that the antenna 104 operates within optimal power levels, avoiding underpowered or overpowered conditions that could degrade performance. The power meter 136 may dynamically adjust the transmission power to maintain consistent signal strength and quality, compensating for environmental changes or variations in signal propagation to maintain efficient communication links and prevent signal loss or distortion.

Further, embodiments may include a sub-nanosecond clock 138, which may be an advanced timing device designed to provide highly accurate and precise synchronization for the operations of the graphene phased array antenna 104. The sub-nanosecond clock 138 may generate timing signals with a resolution of less than one nanosecond for applications requiring ultra-high precision in signal processing and communication. In some embodiments, the sub-nanosecond clock 138 includes an oscillator, such as a crystal oscillator or an atomic clock, that ensures minimal drift and high accuracy over time. The oscillator may be connected to a phase-locked loop, or PLL, a circuit that multiplies the base frequency to achieve the desired sub-nanosecond resolution. In some embodiments, the PLL may ensure that the timing signals remain stable and synchronized with the system's operations. In some embodiments, the sub-nanosecond clock 138 may ensure that the transmission and reception of signals are accurately synchronized to maintain the integrity of the communication link and avoid timing errors that could lead to data corruption or loss. In some embodiments, the sub-nanosecond clock 138 provides precise timestamps for the received signals to allow the base station 102 to accurately calculate the time differences between signals arriving at different elements of the phased array to determine the exact direction of the incoming signals. In some embodiments, the sub-nanosecond clock 138 may enable the base station 102 to measure minute changes in the frequency of the received signals due to the Doppler effect allowing for accurate tracking of the speed and direction of the devices. In some embodiments, the sub-nanosecond clock 138 may provide the timing reference for the digital signal processor, or DSP, and other processing units within the base station 102 to ensure that all data processing tasks are performed in a synchronized manner.

Further, embodiments may include a power source 140, which may be an AC power supply, providing a stable and continuous source of electricity. In some embodiments, the AC power supply ensures that the base station 102 operates without interruption, supporting the continuous monitoring and reporting of wireless device activities within the coverage area. In some embodiments, the base station 102 may rely on DC power sources, such as batteries or rechargeable battery packs. These portable power sources 140 enable the base station 102 to be used in dynamic or remote environments where access to AC power is limited or unavailable. In some embodiments, rechargeable batteries may provide the flexibility of being recharged and reused, making them suitable for operations that require mobility or temporary setups, such as event monitoring, security patrols, or search and rescue missions.

Further, embodiments may include a wireless network controller 142, which may be responsible for managing wireless communications between the base station 102 and the wireless devices within their vicinity. In some embodiments, the wireless network controller 142 may oversee the operations of the NIC 112, including signal monitoring, data capture, and communication with other system components. The wireless network controller 142 may operate by placing the NIC 112 into a specific mode, such as monitor mode, which allows the NIC 112 to passively listen to all wireless traffic within its range without initiating any connections or interactions with the devices being monitored. The wireless network controller 142 may capture various wireless frames, particularly management frames such as probe requests. These frames contain various types of information, including MAC addresses, SSIDs, signal strengths, and supported rates of the wireless devices. By capturing and processing these frames, the wireless network controller helps build a comprehensive profile of each detected device. In some embodiments, the wireless network controller 142 may periodically scan different frequency channels. This scanning process allows the NIC 112 to detect devices operating on various channels, minimizing the chances of missing any signals. Additionally, the wireless network controller 142 may engage in channel hopping, in which the NIC 112 frequently switches between channels at specified intervals, further enhancing the detection capability by broadening the range of monitored frequencies. The wireless network controller 14 may perform data extraction to isolate relevant information from the frames, which may involve focusing on specific details such as MAC addresses, network names (SSIDs), and signal strengths. The extracted data is then preprocessed to filter out irrelevant or redundant information, ensuring that only valuable and pertinent data is retained. The refined data may be structured in a format that facilitates efficient transmission to the system's servers for further processing and analysis. In some embodiments, the wireless network controller 142 may ensure that the data is serialized and encrypted, maintaining the integrity and security of the information during transmission.

Further, embodiments may include a Bluetooth controller 144, which may be responsible for managing Bluetooth communications between the base station 102 and Bluetooth-enabled devices. The Bluetooth controller 144 may control the Bluetooth chipset, enabling the detection, tracking, and processing of Bluetooth signals within the base station's 102 vicinity. In some embodiments, the Bluetooth controller 144 may operate by placing the Bluetooth chipset into a passive monitoring mode. In this mode, the chipset listens to Bluetooth signals within its range without actively connecting or interacting with the devices being monitored. The Bluetooth controller 144 may capture various Bluetooth packets, including device names, Bluetooth addresses, signal strengths, supported services, and other metadata. By capturing and processing these packets, the Bluetooth controller 144 builds a comprehensive profile of each detected Bluetooth-enabled device. In some embodiments, the Bluetooth controller 144 may perform data extraction to isolate relevant information from the packets, which may involve focusing on key details such as Bluetooth addresses, device names, and signal strengths, which form the basis for further analysis and processing. The extracted data is then preprocessed to filter out irrelevant or redundant information, ensuring that only valuable and pertinent data is retained. The refined data is structured in a format that facilitates efficient transmission to the system's servers for further processing and analysis. The Bluetooth controller 144 ensures that the data is serialized and encrypted, maintaining the integrity and security of the information during transmission.

Further, embodiments may include an ethernet port 146, which may be a hardware interface that enables wired network connectivity for the base station 102 and other system components. The ethernet port 146 may facilitate the transmission and reception of data between the base station 102 and the system's servers or other networked devices over a wired Ethernet connection. In some embodiments, the ethernet port 146 may enable the base station 102 to transmit captured and processed data to the system's servers for further analysis and storage. This data may include wireless signal information, device metadata, and other relevant tracking and authentication details.

Further, embodiments may include a memory 148, which may be implemented as flash memory, which contains code logic for various functions including monitoring, reporting, and other processing tasks. The memory 148 may contain various software or modules, such as the operating system, reception module 114, monitor module 116, report module 118, and ASP module 120. The memory 148 may be responsible for temporarily storing the captured wireless signals and their metadata, ensuring that the data is readily accessible for preprocessing and transmission to the system's servers. In some embodiments, the memory 148 may store configuration settings, firmware updates, and other files that enable the base station 102 to function efficiently and effectively.

Further, embodiments may include a cloud 150, or servers, which may serve as the central processing and storage hub, managing the vast amounts of data collected by the base station 102 equipped with graphene phased array antennas 104. The cloud 150 infrastructure may consist of high-performance servers that provide robust computational capabilities for processing and analyzing the data transmitted from the base station 102. In some embodiments, the servers may be designed to handle the complex algorithms for advanced signal processing, including angle of arrival operations, Kalman filtering, and JPDA operations. The cloud 150 performs extensive analysis to extract meaningful insights from the data received from the base station 102., which may include processing the extracted data to determine the location of target devices, filtering out outliers, and refining the tracking data to ensure accuracy. In some embodiments, the cloud 150 may leverage its high-speed computational power to run these algorithms efficiently, providing real-time feedback and updates to the base stations. In some embodiments, the cloud 150 may be responsible for storing the vast amounts of data generated by the system. In some embodiments, the cloud 150 may use advanced storage solutions to ensure that data is securely stored and easily retrievable for further analysis or historical reference.

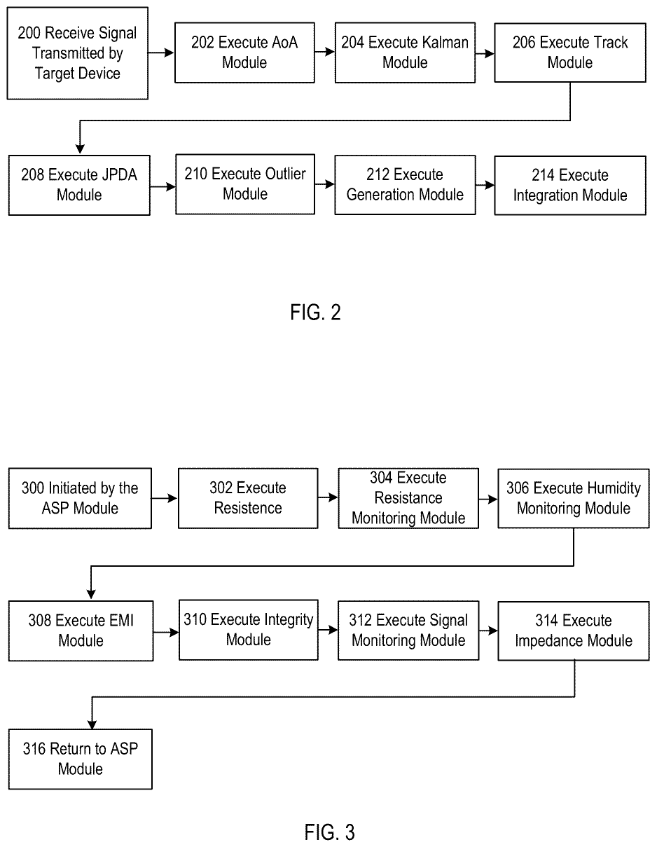

FIG. 2 is a flowchart of a method performed by the ASP module. The process begins with The ASP module 120 receiving, at step 200, the signal transmitted by the target device. The ASP module 120 executes, at step 202, the AoA module 122. The AoA module 122 determines the precise direction from which a wireless signal originates. The AoA module 122 may capture wireless signals through the graphene phased array antenna 104, which is composed of multiple graphene elements arranged in a specific configuration. These elements may dynamically adjust their phase and amplitude to accurately determine the direction of incoming signals. When a signal is received by the antenna 104 array, each element captures the signal at slightly different times due to the spatial separation of the elements. The AoA module 122 processes these time differences to calculate the angle of arrival of the signal. For example, the graphene phased array antenna 104 captures incoming wireless signals from various directions. The ultra-low resistance and high conductivity of graphene ensure minimal signal loss and high-quality reception. The AoA module 122 measures the time differences between when the signal reaches each graphene element. The AoA module 122 calculates the phase differences of the received signal at each element. By analyzing these phase differences, the AoA module 122 may determine the relative phase shifts caused by the different paths the signal takes to reach each element. Using the time distance of arrival and phase difference data, the AoA module 122 may apply algorithms to calculate the precise angle from which the signal originated, which may involve solving geometric equations based on the known positions of the antenna elements and the measured time and phase differences. The graphene elements may dynamically adjust their phase and amplitude to focus on the direction of the incoming signal. The beamforming capability enhances the accuracy of the angle of arrival determination by increasing the signal-to-noise ratio for the specific direction. The AoA module 122 may perform real-time resistance monitoring of the graphene elements to ensure optimal performance. The AoA module 122 may continuously adjust the system parameters to account for environmental factors such as temperature and humidity, which may affect signal propagation and reception. The final angle of arrival data, indicating the precise direction of the incoming signal, is generated and outputted for further processing or immediate use in device tracking applications.

The ASP module 120 executes, at step 204, the Kalman module 124. The Kalman module 124 may accurately predict the position of wireless devices by filtering and smoothing the incoming signal data. The Kalman module 124 may perform advanced estimation techniques, such as the Kalman Filter, to provide real-time tracking and prediction of device movements, ensuring high accuracy and reliability. For example, the graphene phased array antenna 104 may capture incoming wireless signals with high sensitivity due to the superior conductivity and low resistance of graphene. In some embodiments, the initial processing may involve converting these captured signals into a format suitable for further analysis. The Kalman module 124 may initialize the state vector, which represents the device's position and velocity. This state vector is based on the initial measurements obtained from the graphene phased array antenna 104, providing a starting point for the estimation process. The Kalman Filter within the Kalman module 124 may predict the future state of the device using a mathematical model. The model considers the previous state and incorporates assumptions about the device's movement, such as constant velocity or acceleration. The prediction may involve calculating the predicted state vector and the associated uncertainty, for example, using a covariance matrix.

As new signal measurements are received by the graphene phased array antenna 104, the Kalman module 124 updates the predicted state, which may involve comparing the predicted state with the actual measurements and computing the difference, known as the innovation or residual. The Kalman Filter then adjusts the state vector and the covariance matrix based on this innovation The Kalman Gain is calculated to determine the optimal weight given to the new measurements versus the predicted state. The Kalman Gain ensures that the filter adapts appropriately to new information, balancing the influence of the prediction and the measurement. Using the Kalman Gain, the Kalman module 124 may correct the state vector, refining the estimate of the device's position and velocity, which reduces the uncertainty in the state estimate, providing a more accurate and reliable prediction. The covariance matrix, representing the uncertainty of the state estimate, is updated to reflect the new measurements and the correction applied to ensure that the filter maintains an accurate assessment of the estimation uncertainty over time. The refined state vector, which represents a highly accurate estimate of the device's position and velocity, is generated as the output and may be used for real-time tracking, navigation, and other applications requiring precise location information.

The ASP module 120 executes, at step 206, the track module 126. The track module 126 may match incoming signals to their respective tracked devices to ensure that the system maintains accurate and continuous tracking of multiple devices in a dynamic environment. For example, the graphene phased array antenna 104 may capture high-quality signals from multiple devices within its range. In some embodiments, the captured signals may undergo initial preprocessing to extract relevant features such as signal strength, time of arrival, and angle of arrival. For each incoming signal, the track module 126 may generate a list of potential matches, or candidates, from the existing set of tracked devices, which may involve comparing the extracted signal features with the expected features of the tracked devices based on their predicted positions and characteristics. The track module 126 calculates the likelihood that each candidate device is the source of the incoming signal. The calculation takes into account factors such as the proximity of the predicted position to the signal's point of origin and the similarity of the signal characteristics. In some embodiments, the track module 126 may use advanced algorithms, such as the Joint Probabilistic Data Association or JPDA, to optimize the assignment of signals to devices. The JPDA algorithm may evaluate all possible assignments and select the one that maximizes the overall likelihood to ensure that the signals are matched to their correct sources. In some embodiments, multiple devices may have similar likelihoods for a given signal, the track module 126 may employ additional criteria to resolve ambiguities, which may include historical movement patterns, signal strength trends, and other contextual information. The track module 126 may output the final assignments of signals to devices, providing a clear and accurate mapping of incoming signals to their respective sources. In some embodiments, the mapping may be used to update the state estimates of the tracked devices. The track module 126 may be responsible for maintaining and updating the tracks of devices over time. The track module 126 ensures that the tracking system can handle the initiation, maintenance, and termination of device tracks, providing continuous and accurate tracking of multiple devices. In some embodiments, the track module 126 uses the captured signal to initiate a new track, assigning a unique identifier and recording the initial position and velocity of the device. For each tracked device, the track module 126 updates its state based on new signal measurements received by the graphene phased array antenna 104, which may involve incorporating the latest position, velocity, and other relevant features into the existing track. The track module 126 may predict the future position and state of each tracked device using mathematical models, which assist in maintaining continuous tracking even when signals are temporarily lost or obstructed. The track module 126 confirms the existence of a track by continuously receiving and associating signals from the device over a specified period. In some embodiments, tracks that do not receive consistent signal updates are flagged for potential termination. The track module 126 terminates tracks for devices that have left the monitoring range or have not been detected for an extended period, which may involve removing the track from the active list and recording the last known state of the device. The track module 126 may maintain the integrity of each track by handling track splits and merges. For example, if a device's signal splits into multiple tracks or if multiple tracks converge into one, the track module 126 may resolve these situations to ensure accurate tracking. In some embodiments, the track module 126 may store historical data for each track, including the device's movement patterns, signal characteristics, and state estimates.

The ASP module 120 executes, at step 208, the JPDA module 128. The JPDA module 128 may improve the accuracy and reliability of data association in a dense signal environment. The graphene phased array antenna 104 captures high-quality wireless signals from multiple devices. In some embodiments, the JPDA module 128 may receive the preprocessed signals, which include key features such as angle of arrival, time of arrival, and signal strength, and use these features to generate a preliminary association of signals to their respective tracked devices. The JPDA module 128 performs the Joint Probabilistic Data Association (JPDA) algorithm to handle situations where multiple signals may correspond to multiple devices. JPDA calculates the probabilities of different possible associations, considering the uncertainties and variances in signal measurements. For each potential association, the JPDA module 128 calculates a likelihood score based on the consistency of the signal characteristics with the expected values for each tracked device, which may include factors such as predicted positions and signal properties derived from the graphene phased array antenna 104. The JPDA module 128 may optimize the overall data association by selecting the set of associations that maximize the joint probability. In some embodiments, the clean aspect of the JPDA module 128 may involve filtering out unlikely associations and ensuring that each signal is assigned to the most probable device without overlaps or conflicts. In some embodiments, the JPDA module 128 identifies and removes outliers that do not fit any probable track. In some embodiments, the outliers could be due to noise, spurious signals, or devices temporarily leaving the monitoring range. In some embodiments, the high sensitivity and accuracy of the graphene phased array antenna 104 help in distinguishing true signals from outliers. The JPDA module 128 outputs the optimized association of signals to devices. In some embodiments, the association is used to update the state estimates and positions of the tracked devices to ensure accurate and continuous tracking. The JPDA module 128 may continuously monitor its performance, adjusting the parameters of the JPDA algorithm based on real-time feedback to ensure that the JPDA module 128 remains adaptive and robust in varying signal environments.

The ASP module 120 executes, at step 210, the outlier module 130. The outlier module 130 may handle measurements that arrive out of their expected order. The outlier module 130 may ensure that the tracking system maintains high accuracy and reliability, even when data packets are delayed or received in an unexpected sequence. Each received signal is timestamped with the exact time of arrival and the outlier module 130 temporarily stores the received signals in a buffer. The outlier module 130 sorts the signals based on their timestamps to determine the correct sequence of events. The outlier module 130 may analyze the sequence of the buffered signals to identify any out-of-sequence measurements and may compare the timestamps and expected order of the signals to detect discrepancies. In some embodiments, if an out-of-sequence measurement is identified, the outlier module 130 adjusts the state estimates of the tracked devices. In some embodiments, the outlier module 130 recalculates the positions and velocities of the devices based on the corrected sequence of signals. The outlier module 130 may utilize a Kalman filter to update the state estimates with the out-of-sequence data. The outlier module 130 may correct any errors introduced by the out-of-sequence measurements by recalibrating the tracking system to ensure that the device positions and velocities are consistent with the corrected data sequence. In some embodiments, the corrected and updated state estimates are integrated into the overall tracking system. The outlier module 130 may ensure that the tracking system maintains a continuous and accurate representation of the device positions and movements.

The ASP module 120 executes, at step 212, the generation module 132. The generation module 132 transforms raw sensor data into a usable format for further processing and analysis. The generation module 132 ensures that the data collected, such as the signals from the graphene phased array antenna 104, is accurately converted and prepared for integration into the tracking system. In some embodiments, the graphene phased array antenna 104 captures signals from multiple devices and the generation module 132 may receive the raw sensor data, including various parameters such as signal strength, frequency, phase information, and other relevant metrics. In some embodiments, the raw data may undergo initial preprocessing to remove any noise or irrelevant information. The preprocessed data is then converted into a standardized format that can be easily processed by the tracking system which may involve translating the raw sensor readings into digital values, ensuring compatibility with the system's data processing protocols. The generation module 132 may standardize the units of measurement for the converted data to ensure consistency across different datasets and simplify the integration of data. The generation module 132 may apply calibration adjustments to the converted data based on the characteristics of the graphene phased array antenna 104 to ensure that the data reflects accurate measurements, accounting for any variations introduced by the system's hardware. In some embodiments, each data point is timestamped to ensure accurate tracking of the temporal sequence of events. The converted and standardized data is then packaged into a format suitable for transmission and further processing which may involve organizing the data into structured packets that can be easily interpreted by the tracking system. The generation module 132 may prepare the packaged data for transmission to the central processing unit of the tracking system. In some embodiments, the converted, standardized, and quality-assured data may be transmitted to a central processing unit of the tracking system.

The ASP module 120 executes, at step 214, the integration module 134. The integration module 134 may optimize the performance of the graphene phased array antenna 104 by incorporating various monitoring and adjustment modules, including modules for measuring and monitoring resistance, real-time resistance for receiving circuits, and enhanced reception and transmission tuned to graphene's properties. In some embodiments, the integration module 134 features adaptive signal processing, temperature and humidity monitoring, electromagnetic interference detection, structural integrity assessment, signal strength monitoring, frequency response monitoring, and impedance matching. In some embodiments, the modules within the integration module 134 may work together to dynamically optimize the antenna's 104 performance to provide robust and reliable communication by continuously adapting to environmental conditions.

FIG. 3 is a flow chart of a method performed by the integration module. The process begins with the integration module 134 being initiated, at step 300, by the ASP module 120. The integration module 134 executes, at step 302, the resistance measurement module. The resistance measurement module may continuously monitor and measure the resistance of the graphene-based phase shifters in real-time. The resistance measurement module may comprise a series of precision resistive sensors directly connected to the graphene phase shifters. The sensors may capture minute changes in resistance due to various environmental factors and usage over time. The data collected by the resistive sensors may be sent to an integrated microcontroller unit, or MCU for processing and analysis. In some embodiments, the MCU may interpret the raw data from the sensors and transform it into actionable insights. In some embodiments, the resistance measurement module may receive input from the graphene monitor 110, which provides detailed environmental data such as temperature and humidity levels and by integrating this data, the MCU may more accurately assess how these factors influence the resistance of the graphene phase shifters. By continuously monitoring resistance, the MCU may detect variations caused by temperature changes, humidity, and physical stress, which may impact the performance of the graphene-based phase shifters and, consequently, the quality of signal processing and beam steering.

In some embodiments, the MCU may send the processed resistance data to the receiver circuits. The receiver circuits may use this data to dynamically adjust their signal processing parameters to match the current state of the graphene phase shifters. For example, if the resistance increases due to high humidity, the receiver circuits may boost the signal gain and adjust the filter settings to compensate for potential signal loss, and if the resistance decreases due to cooler temperatures, the circuits may reduce the gain to prevent over-amplification and maintain optimal signal clarity.

The integration module 134 executes, at step 304, the resistance monitoring module. The resistance monitoring module may provide real-time monitoring of the graphene-based phase shifters'resistance for the receiving circuits. The resistance monitoring module may include a set of specialized sensors and an MCU that continuously collects and analyzes resistance data. In some embodiments, the sensors may be placed to measure the resistance of the graphene phase shifters with high precision, capturing changes due to environmental factors such as temperature, humidity, and physical stress. In some embodiments, the resistance monitoring module may receive input from the graphene monitor 110, which provides detailed environmental data allowing for a more comprehensive analysis of how these environmental factors affect the resistance of the graphene phase shifters. The MCU processes the resistance data and dynamically adjusts the parameters of the receiving circuits to ensure optimal signal reception. For example, the resistance monitoring module for the graphene-based receiving circuits may continuously optimize signal reception by measuring the phase shifters'resistance, which can range from 0.5 to 5 ohms due to environmental factors like temperature and humidity. The precision sensors on the graphene phase shifters may feed real-time resistance data to the MCU. The MCU processes this data and dynamically adjusts the receiving circuit parameters. For example, in normal conditions with resistance between 0.8 and 1.2 ohms, standard gain and filter settings are maintained. If resistance increases to 3.0-5.0 ohms due to humidity, the MCU may boost amplifier gain and adjust filter bandwidth to compensate for signal attenuation, and if resistance drops to 0.5-0.7 ohms, indicating cooler temperatures, the MCU decreases gain to prevent over-amplification. In some embodiments, the system may dynamically respond to changing conditions, such as a dense urban area, to ensure clear reception even during environmental fluctuations and maintain robust and reliable communication for accurate device tracking and interaction. The integration module 134 executes, at step 306, the humidity monitoring module. The humidity monitoring module may provide optimal performance for the graphene-based phase shifters by continuously monitoring the humidity levels in their environment. The humidity monitoring module may include a set of hygrometers and a processing unit that measures and analyzes the moisture content in the air surrounding the graphene phase shifters. In some embodiments, the humidity monitoring module may receive input from the graphene monitor 110, which provides environmental data, including temperature and other factors that may affect the graphene's properties allowing for an improved understanding of how environmental conditions impact the graphene phase shifters. The hygrometers, which measure the moisture content in the air, may be positioned around the graphene phase shifters to provide accurate and real-time data on environmental humidity. The data collected by the hygrometers may be transmitted to the processing unit, which acts as the central hub for analyzing and responding to changes in humidity. The processing unit receives the humidity data and conducts a detailed analysis to determine how the current humidity levels might impact the performance of the graphene phase shifters. For example, higher humidity levels may increase the resistance of graphene, leading to potential signal attenuation and degradation in signal quality, while lower humidity levels may decrease resistance, potentially causing over-amplification issues. In some embodiments, the processing unit dynamically adjusts the operational parameters of the antenna system based on the analyzed data. For example, if the humidity levels rise above a certain threshold, the humidity monitoring module may increase the power and adjust the filtering algorithms to compensate for the increased resistance, ensuring strong and clear signal transmission and reception, and if the humidity levels drop, the module may reduce the power to prevent overloading and maintain signal clarity.

The integration module 134 executes, at step 308, the EMI module. The EMI module maintains the signal integrity and performance of the graphene-based phase shifters by continuously detecting and mitigating electromagnetic interference, or EMI, in the operational environment. The EMI module may be equipped with EMI sensors and a processing unit that identifies sources of interference and adjusts the base station's 102 signal processing parameters accordingly. The EMI sensors may be designed to continuously scan the surrounding environment for any electromagnetic interference. The EMI sensors may be highly sensitive and capable of detecting various sources of EMI, such as nearby electronic devices, power lines, or communication equipment. The data collected by these sensors may be sent to the processing unit, which acts as the control center for analyzing the interference and making adjustments to the system. In some embodiments, the EMI module may receive input from the graphene monitor 110, which provides environmental data, including data on temperature, humidity, and other factors that may influence the performance of the graphene phase shifters to accurately assess the impact of environmental conditions and interference on the system. The processing unit receives the EMI data and performs a detailed analysis to determine the type and severity of the interference. In some embodiments, the ultra-sensitivity and low resistance of graphene phase shifters may allow small amounts of external noise to significantly impact signal quality. The processing unit uses the analysis to dynamically adjust the signal processing algorithms to filter out or compensate for the detected interference. For example, if the EMI sensors detect a spike in interference causing the graphene phase shifters'resistance to increase temporarily, the processing unit may enhance the noise filtering capabilities and increase the signal strength to maintain clarity. When the interference subsides and resistance levels return to normal, the system reverts to standard processing settings to ensure efficiency.

The integration module 134 executes, at step 310, the integrity module. The integrity module may ensure the longevity and reliability of the graphene-based phase shifters by continuously monitoring their physical condition. The integrity module may utilize strain gauges and vibration sensors to detect any structural damage or wear over time. In some embodiments, the strain gauges and vibration sensors may be attached to the graphene phase shifters to measure any physical stress, deformation, or vibrations that these components experience. The strain gauges may be designed to detect minute changes in the physical structure of the phase shifters by measuring strain or deformation, and the vibration sensors may monitor any vibrations that may indicate potential structural issues. In some embodiments, the integrity module may receive input from the graphene monitor 110, which may provide environmental data that may affect the structural integrity of the graphene phase shifters, including temperature fluctuations, humidity levels, and other environmental factors that might contribute to physical stress or degradation over time. The data collected from these sensors may be transmitted to the processing unit within the integrity module. The processing unit analyzes the data in real time to identify any signs of structural damage or wear that may compromise the performance of the graphene phase shifters. For example, when the processing unit detects any anomalies or deviations from normal structural behavior, it assesses the severity of these issues and determines the appropriate response. For minor deformations or vibrations, the system might continue to operate while flagging the issue for maintenance checks. If the detected structural issues are significant, the processing unit may alert the system to take corrective actions, such as adjusting the operational parameters to prevent further damage or initiating maintenance protocols to address the identified problems.

The integration module 134 executes, at step 312, the signal monitoring module. The signal monitoring module may ensure the quality and reliability of communication by continuously monitoring the strength of signals received and transmitted by the graphene-based phase shifters. The signal monitoring module may include signal strength meters and a processing unit that measures and analyzes the power of incoming and outgoing signals in real time. In some embodiments, the signal strength meters may be calibrated to accurately measure the power levels of signals interacting with the graphene phase shifters. The meters may capture data on both the strength of signals being received from various devices and the power of signals being transmitted by the system. The collected signal strength data is then sent to the processing unit within the signal monitoring module. In some embodiments, the signal monitoring module may receive input from the graphene monitor 110, which may provide data on environmental conditions such as temperature and humidity, which may influence the electrical properties of the graphene phase shifters, potentially affecting signal strength. The processing unit analyzes the signal strength data to determine the current state of signal power and may detect any variations or fluctuations in signal strength that might impact communication quality. For example, if the processing unit identifies that the signal strength is weaker than optimal, it dynamically adjusts the transmission power and reception sensitivity to compensate for the detected weaknesses. For example, if the received signal strength is low, the signal monitoring module may increase the gain of the receiver to enhance the clarity and quality of incoming signals, and if the transmitted signal strength is insufficient to reach the intended devices, the signal monitoring module may boost the transmission power to ensure the signals are strong and clear.

The integration module 134 executes, at step 314, the impedance module. The impedance module may ensure proper impedance matching between the graphene-based phase shifters and the transmitter and receiver circuits. The impedance module may incorporate impedance analyzers and a processing unit to monitor and adjust the impedance of the graphene phase shifters in real-time. In some embodiments, the impedance analyzers may be devices that continuously measure the impedance of the graphene phase shifters, capturing values and any fluctuations due to environmental changes or operational conditions. The collected impedance data may be transmitted to the processing unit within the impedance module. In some embodiments, the impedance module may receive input from the graphene monitor 110, which provides environmental data such as temperature and humidity that may influence the electrical properties of the graphene phase shifters, potentially affecting their impedance. The processing unit analyzes the impedance data to determine whether the current values are optimal for efficient signal transmission and reception. Proper impedance matching minimizes signal reflection and maximizes power transfer between the graphene phase shifters and the circuits. A mismatch in impedance may lead to signal loss, reduced transmission power, and overall inefficiency. If the processing unit detects any discrepancies in the impedance values, it dynamically adjusts the matching circuits to correct these issues. The adjustment process may involve fine-tuning the impedance settings to ensure they align with the optimal range for the current operating conditions. For example, if the impedance rises due to increased humidity or temperature changes, the processing unit may increase the transmission power and adjust the impedance matching circuits to maintain strong and clear signals, and if the impedance drops, indicating cooler temperatures or reduced interference, the impedance module may reduce the transmission power and fine-tune the impedance settings to prevent overloading. The integration module 134 returns, at step 316, to the ASP module 120.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system for wireless device tracking comprising:
a graphene phased array antenna configured to receive wireless signals from a plurality of wireless devices in an environment, wherein the graphene phased array antenna includes graphene-based phase shifters arranged in a predetermined configuration;
a signal processor configured to calculate an angle from which each wireless signal arrives to triangulate a location of each wireless device within the environment based on relative phase shifts caused by different paths the wireless signals take to reach each graphene-based phase shifter of the graphene phased array antenna;
an integration module configured to optimize performance of the graphene phased array antenna based on one or more conditions in the environment; and
a network interface configured to transmit the location of each of the plurality of wireless devices to a remote system.

2. The system of claim 1, wherein the one or more conditions in the environment include one or more of temperature or humidity, wherein the integration module includes a resistance monitoring module configured to provide real-time monitoring of changes of resistance of the graphene-based phase shifters due to the one or more conditions in the environment, and wherein the integration module is configured to adjust one or more parameters of the graphene phased array antenna in response to the changes of resistance.

3. The system of claim 2, wherein the one or more parameters include amplifier gain or filter bandwidth.

4. The system of claim 1, wherein the integration module includes an electromagnetic interference (EMI) module configured to provide real-time monitoring of changes of EMI in the environment, and wherein the integration module is configured to filter out or compensate for detected EMI.

5. The system of claim 1, wherein the integration module includes an integrity module configured to continuously monitor the graphene-based phase shifters for one or more signs of a physical change in structure, and wherein the integration module is configured, in response to detecting the one or more signs of the physical change in the structure of the graphene-based phase shifters, to generate an alert.

6. The system of claim 5, wherein the one or more signs of the physical change in the structure of the graphene-based phase shifters include strain, deformation, or vibration.

7. The system of claim 1, wherein the integration module includes a signal monitoring module configured to continuously monitor signals received or transmitted by the graphene-based phase shifters, and wherein the integration module is configured, in response to detecting signal strengths outside of a predetermine range, to dynamically adjust one or both of transmission power and reception sensitivity of the graphene phased array antenna.

8. The system of claim 7, wherein the integration module includes an impedance module configured to monitor an impedance of the graphene-based phase shifters and adjust the impedance in response to detection of an impedance mismatch.

9. The system of claim 1, wherein the graphene phased array antenna is configured to operate in a passive mode without transmitting a wireless signal to the plurality of wireless devices.

10. The system of claim 1, wherein the graphene phased array antenna is further configured, prior to receiving the wireless signals, to transmit at least one wireless signal to the plurality of wireless devices.

11. The system of claim 1, wherein the graphene phased array antenna is configured to operate as an Active Electronically Scanned Array (AESA), and wherein each graphene-based phase shifter is equipped with individual transmit/receive modules allowing for independent control of each graphene-based phase shifter.

12. The system of claim 11, wherein the individual transmit/receive modules are configured to perform at least one of actively steering beams, scanning multiple directions simultaneously, providing targeting and tracking capabilities, and providing beam shaping and adaptation to changing signal environments.

13. The system of claim 1, wherein the signal processor includes a Kalman module configured to predict a position in the environment of each wireless device of the plurality of wireless devices by filtering and smoothing the wireless signals.

14. The system of claim 13, wherein the Kalman module is further configured to:
initialize a state vector representing the position and a velocity of a first wireless device, the state vector being based on initial measurements obtained from the graphene phased array antenna; and
use a Kalman filter to predict a future state of the first wireless device using a mathematical model.

15. The system of claim 14, wherein the mathematical model considers a previous state and incorporates one or more assumptions about movement of the first wireless device to make a prediction by calculating a predicted state vector and an associated uncertainty using a covariance matrix.

16. The system of claim 15, wherein the one or more assumptions include at least one of constant velocity or acceleration.

17. The system of claim 15, wherein the Kalman module compares the predicted state vector with actual measurements to compute a residual, and wherein the Kalman filter adjusts the state vector and the covariance matrix based on the residual.

18. The system of claim 1, further comprising a track module configured to match the wireless signals to respective tracked devices by:
preprocessing the wireless signals to extract signal features; and
for each incoming signal, comparing the extracted signal features to generate a list of potential matches from an existing set of tracked devices.

19. The system of claim 18, wherein the extracted signal features include one or more of signal strength, time of arrival, and angle of arrival.

20. The system of claim 18, further comprising a Joint Probabilistic Data Association (JPDA) module configured to optimize assignment of the wireless signals to wireless devices.

21. The system of claim 20, wherein the JPDA module is configured to evaluate all possible assignments and select a first assignment that maximizes an overall likelihood of being a match.

22. The system of claim 21, wherein the JPDA module calculates a likelihood score based on consistency of the extracted signal features with expected values for each tracked wireless device.

23. A method for wireless device tracking comprising:
receiving, via a graphene phased array antenna, wireless signals from a plurality of wireless devices in an environment, wherein the graphene phased array antenna includes graphene-based phase shifters arranged in a predetermined configuration;
calculating, via a signal processor, an angle from which each wireless signal arrives to triangulate a location of each wireless device within the environment based on relative phase shifts caused by different paths the wireless signals take to reach each graphene-based phase shifter of the graphene phased array antenna;
optimizing performance of the graphene phased array antenna based on one or more conditions in the environment; and
transmitting the location of each of the plurality of wireless devices to a remote system.
